(19) United States
(12) Patent Application Publication
(10) Pub. No.: US 2022/0082865 A1
(43) Pub. Date: Mar. 17, 2022

(54) A UNIVERSAL BUOYANCY DEVICE FOR SPECTACLES

(71) Applicant: Moshe ROIMI, Petah Tikva (IL)

(72) Inventors: Avi ROIMI, Binyamina (IL); Moshe ROIMI, Petah Tikva (IL)

(21) Appl. No.: 17/420,499

(22) PCT Filed: Dec. 26, 2019
(86) PCT No.: PCT/IL2019/051412

§ 371 Date: Jul. 2, 2021

(30) Foreign Application Priority Data
Jan. 7, 2019 (IL) 264132

(51) Int. Cl. G02C 11/00

(52) U.S. Cl. CPC G02C 11/00

(57) ABSTRACT

The present invention is a universal buoyancy device for spectacles, comprising: a buoyancy element, and a round cross sectional elastic strap; wherein the elastic strap is embedded in two crossing channels within the buoyancy element, leaving two free loops on the element's extremities, allowing a limited sliding capability of the strap when a free loop is pulled during attachment to spectacles' temple, while the element's shape ensure a gap between the channels to the spectacles' temple, ensuring residual stress within the strap and therefore a firm securement to the spectacles.

### FIELD OF THE INVENTION

The invention is in the field of buoyancy devices. More particularly, the present invention relates to a universal buoyancy device for spectacles.

### BACKGROUND OF THE INVENTION

Spectacles are in a common use for health, convenience and fashion reason. Unfortunately, many spectacles are lost during outdoor activities, which can be both dangerous (i.e., losing sun shading or optical aid at sea) and highly frustrating, especially during maritime activities where the retrieval of lost items is nearly impossible.

The prior art propose hollow buoyancy devices which are slipped over the spectacle's temples, or devices with rigid or elastic bands which slips over the temples. Other devices dangle on straps with sleeves that are slipped over said temple's free edges. Adapting a single device of the prior art to multiple spectacles of different designs does not provide with the required securement for tough conditions, while devices of the prior art which provide sufficient securement, are unadaptable to multiple spectacles of different temple's sizes and shapes, which induce redundant costs to consumers who replace spectacles or use more than one pair of spectacles.

Additionally, since said spectacles are mostly in general use and not only during maritime activity, the buoyancy aiding device is required to be easily installed and removed. Newer solutions of the prior art with embedded floating elements or with a frame molded with air cavities/bubbles, are expensive, unadaptable to differently designed spectacles and cannot be removed.

The objective of the present invention is to provide with a single low cost device, which is easily installed and secured on differently designed spectacle's temples, thus overcoming the shortcoming of the prior art.

It is yet another objective of the present invention to provide with a protruding buoyancy device, which can be easily located and retrieved while floating at sea level, yet easily removable, to allow the regular use of same spectacles of unaffected original design.

### SUMMARY OF THE INVENTION

The present invention is a universal buoyancy device for spectacles, comprising:
a buoyancy element;
a round cross sectional elastic strap;
wherein said elastic strap is embedded in two crossing channels within said buoyancy element, leaving two free loops on said element's extremities, allowing a limited sliding capability of said strap when a free loop is pulled during attachment to spectacles' temple, while said element's shape ensure a gap between said channels to the spectacles' temple, ensuring residual stress within said strap and therefore a firm securement to said spectacles.

According to an embodiment of the invention, the buoyancy element is of ellipse shape.

According to an embodiment of the invention, the buoyancy element is constructed of a single piece molded foam material.

According to an embodiment of the invention, the buoyancy element is made of a closed cell cross-linked polyethylene foam block.

According to an embodiment of the invention, the buoyancy element is comprised of two parts.

According to an embodiment of the invention, the buoyancy element is comprised of additional plate, e.g., that is designed with noticeable painting, a commercial logo, or any desired graphics and/or text, attached to its outwards facing surface.

According to an embodiment of the invention, the buoyancy element is comprised of a socket allowing the smooth adaption of an additional plate, e.g., that is designed with a noticeable painting or a commercial logo.

### BRIEF DESCRIPTION OF THE DRAWINGS

FIG. 1 schematically illustrates a perspective view of a buoyancy device for spectacles, according to an embodiment of the invention;

FIG. 2 schematically illustrates a partial perspective view of a strap and sectioned buoyancy element of the buoyancy device of FIG. 1, according to an embodiment of the present invention;

FIGS. 3A-3C schematically illustrate a top view of an attachment sequence of the buoyancy device of FIG. 1 to a spectacles' temple; and

FIG. 4 schematically illustrates a perspective view of another embodiment of the present invention.

### DETAILED DESCRIPTION OF THE DRAWINGS

The present invention relates to a buoyancy device, which is comprised of a lightweight buoyancy element (i.e., constructed of low density material) with two parallel crossing channels, through which a round cross sectional elastic strap is adapted, leaving two free loops on both sides of said body.

The fitment between said strap to said crossing channels allows a limited sliding capability of said strap when pulled from one of said device's extremity, extending the loop perimeter at one side of said body (thus reducing the loop perimeter on the other side) to allow an easy sliding of said device on a spectacle's temple, then pulling the other side of strap (thus reducing the loop on the first side) to allow the sliding of the second half-rounded loop over said temple, to be followed by sliding said device to its final position and balancing the tension of between both loops, to ensure the grasp of said temple by both loops.

The geometric shape of said buoyancy element keeps the aforesaid crossing channels at a certain distance from the spectacles' temple, to ensure residual stress within the strap and therefore a firm securement to said spectacles.

All the above will be better understood through the following illustrative and non-limitative examples.

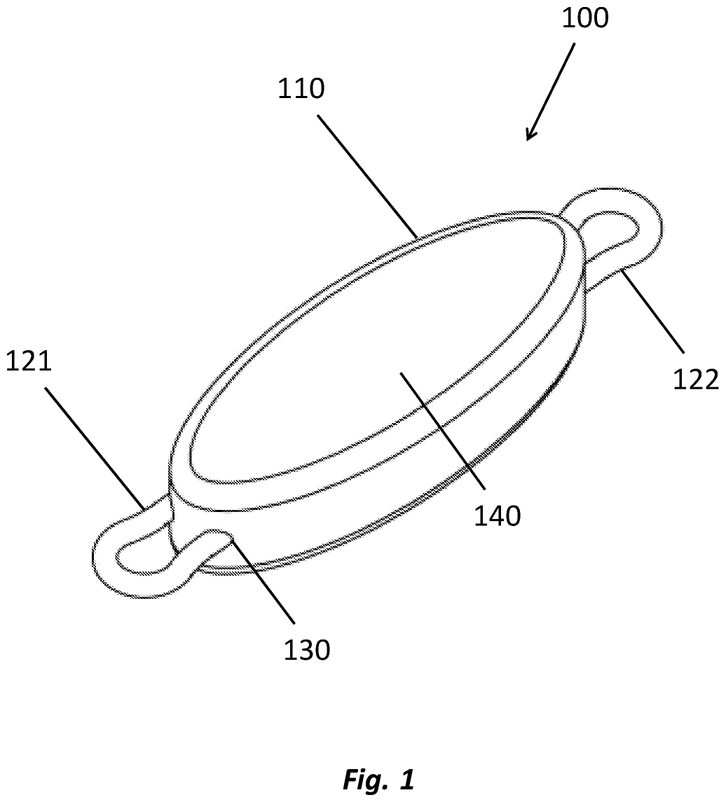

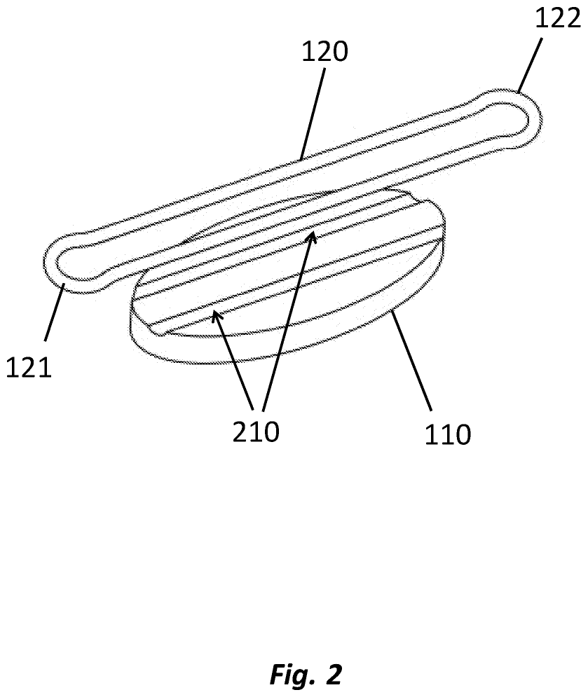

FIG. 1 shows a perspective view of an embodiment of the present invention, in which the invented device 100 is comprised of ellipse shaped buoyancy element 110 of a single piece molded foam material with a high buoyancy capacity and a flexible strap 120 (shown in FIG. 2), which is embedded within two parallel channels (shown in FIG. 2) crossing said buoyancy element 110, while leaving free excess loops 121 and 122 on said element's 110 extremities. The elliptical shape of said element 110 creates an ellipse contour 130 of said channels at the perimeter of said element, allowing an easy expansion of the free loops 121 and 122 during securement to spectacles' temple. For example, the foam material can be made of a closed cell cross-linked polyethylene foam block, such as PalFoam or PA30 by Palziv.

FIG. 2 shows a partial perspective view of a strap and sectioned buoyancy element, according to an embodiment of the present invention, in which two parallel channels, in which said strap 120 is embedded are crossing said buoyancy element 110.

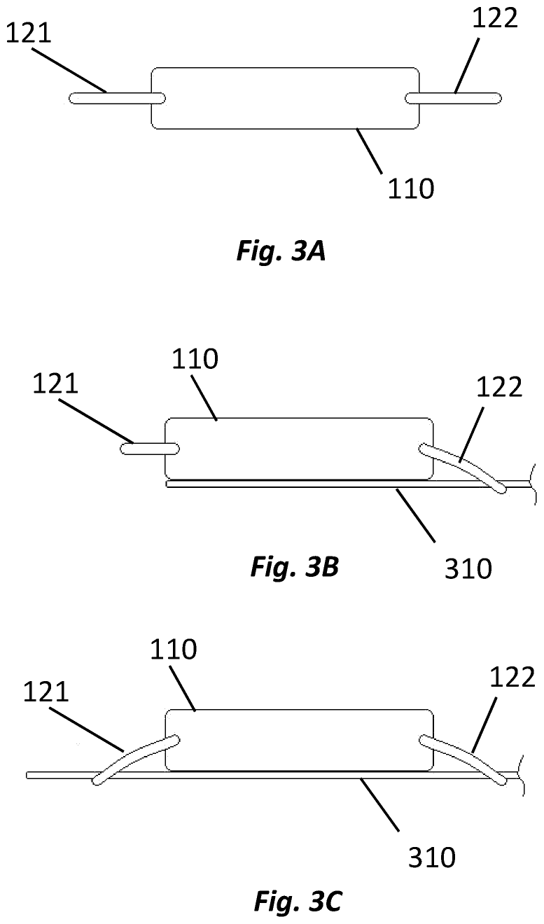

FIGS. 3A thru 3C shows a top illustration of the invented device's attachment to a spectacles' temple, according to an embodiment of the present invention, in which two free loops 121 and 122 of strap 120 (shown in FIG. 2) are on both sides of said buoyancy element 110 and the attachment to a spectacles' temple 310 begins (see FIG. 3B) with the extension of the free loop 122 (thus reducing the second loop 121) to allow a smooth sliding on temple 310. As soon as loop 122 confines temple 310, the other free loop 121 is extended moderately to allow its easy sliding onto temple 310. The last step is balancing the tension on both loops 121 and 122 thus ensuring evenly securement to temple 310.

According to another embodiment of the present invention, the invented device is attached to spectacles with fashionable thin temples, where the flexibility of strap 120 enable further folding of free loop 121 to form at least two overlapping securement loops onto spectacle's thin temple and the same with free loop 122 as required.

One could obviously realize that the smooth surface 140 of device 100 of FIG. 1 allows the attachment (e.g., by adhesion) of a suitable plate designed for example with a noticeable design, or a desirable commercial logo, which can be applied in multiple embodiments of the present invention.

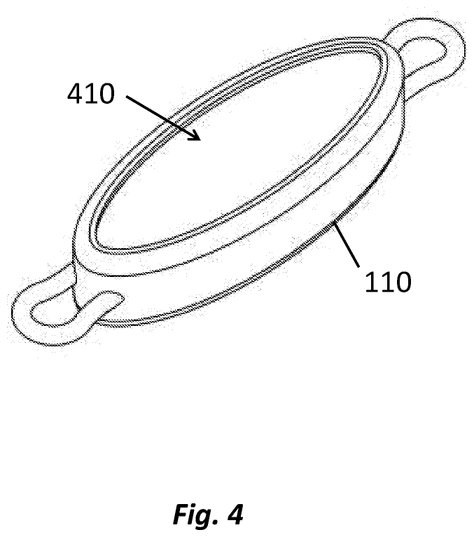

FIG. 4 shows a perspective view of yet another embodiment of the present invention, in which aforesaid buoyancy element 110, is comprised of a socket 410 into which an additional plate designed with a noticeable painting or a commercial logo can be embedded, thus further easing on the locating of spectacles floating at sea surface.

Although embodiments of the invention have been described by way of illustration, it will be understood that the invention may be carried out with many variations, modifications, and adaptations of shapes and materials, without exceeding the scope of the claims.

1. A universal buoyancy device for spectacles, comprising:
a) a buoyancy element; and
b) a round cross sectional elastic strap;
wherein said elastic strap is embedded in two crossing channels within said buoyancy element, leaving two free loops on said element's extremities, allowing a limited sliding capability of said strap when a free loop is pulled during attachment to spectacles' temple, while said element's shape ensure a gap between said channels to the spectacles' temple, ensuring residual stress within said strap and therefore a firm securement to said spectacles.

2. The device of claim 1, in which the buoyancy element is of ellipse shape.

3. The device of claim 1, in which the buoyancy element is constructed of a single piece molded foam material.

4. The device of claim 1, in which the buoyancy element is made of a closed cell cross-linked polyethylene foam block.

5. The device of claim 1, in which the buoyancy element is comprised of two parts.

6. The device of claim 1, in which the buoyancy element is comprised of an additional plate attached to its outwards facing surface, wherein said plate adapted for displaying a desired graphics and/or text.

7. The device of claim 1, in which the buoyancy element is comprised of a socket allowing the smooth adaption of an additional plate, wherein said plate adapted for displaying a desired graphics and/or text.
